(19) United States
(12) Patent Application Publication
(10) Pub. No.: US 2019/0370364 A1
(43) Pub. Date: Dec. 5, 2019

(54) PROCESSING SYSTEM TO FACILITATE UPDATE OF EXISTING ELECTRONIC RECORD INFORMATION

(71) Applicants: Peter J. Casatelli, Deansboro, NY (US); Michael J. Gibson, JR., Southington, CT (US); Jonathan David Humpherys, Weatogue, CT (US); Brian Michael Ignatowicz, West Hartford, CT (US); Michael A. Santosuosso, Haddon Township, NJ (US); Mia B. Sarubbi, Tomball, TX (US); Matthew J. Vitiello, East Hampton, CT (US)

(72) Inventors: Peter J. Casatelli, Deansboro, NY (US); Michael J. Gibson, JR., Southington, CT (US); Jonathan David Humpherys, Weatogue, CT (US); Brian Michael Ignatowicz, West Hartford, CT (US); Michael A. Santosuosso, Haddon Township, NJ (US); Mia B. Sarubbi, Tomball, TX (US); Matthew J. Vitiello, East Hampton, CT (US)

(21) Appl. No.: 16/000,151

(22) Filed: Jun. 5, 2018

(51) Int. Cl. G06F 17/30; G06Q 40/08; G06Q 40/00

(52) U.S. Cl. CPC G06F 17/30345; G06F 3/0481; G06Q 40/12; G06Q 40/08

(57) ABSTRACT

An existing risk relationship data store may contain electronic records representing a plurality of existing risk relationships and, for each existing risk relationship, an electronic record identifier and a set of existing attribute values including an existing resource value. A back-end application computer server may receive an indication of a selected risk relationship and display at least some of the associated existing attribute values. The server may receive adjustments to some of the existing attribute values, and displayed information may be automatically and dynamically configured based on the received adjustments and a pre-determined logic rule. When an adjusted attribute value differs from an existing attribute value by more than a threshold amount, a confirmation signal from a user device may be requested. When adjustments have been completed, the server may automatically estimate an adjusted resource value based on the existing resource value, the adjusted attribute values, and an estimation algorithm.

### BACKGROUND

Electronic records, such as files and database entries, may be stored and utilized by an enterprise. In some cases, the enterprise may want to verify the content of one or more electronic records. For example, more accurate electronic records may improve the performance of the enterprise. Moreover, different verification techniques or processes may be utilized and different verification processes may be associated with different costs, delays, improvements in data accuracy, etc. Note that improving the accuracy of electronic records may result in substantial improvements to the operation of a network (e.g., by reducing an overall number of electronic messages that need to be created and transmitted via the network). Manually executing a verification process by an enterprise, however, can be a time consuming and expensive—especially when a substantial number of electronic records (e.g., tens of thousands of records) and/or a wide range of different types of information need to be verified.

It would be desirable to provide systems and methods to update existing electronic record information in a way that provides faster, more accurate results.

### SUMMARY OF THE INVENTION

According to some embodiments, systems, methods, apparatus, computer program code and means are provided to update existing electronic record information in a way that provides faster, more accurate results and that allow for flexibility and effectiveness when responding to those results. In some embodiments, an existing risk relationship data store may contain electronic records representing a plurality of existing risk relationships and, for each existing risk relationship, an electronic record identifier and a set of existing attribute values including an existing resource value. A back-end application computer server may receive an indication of a selected risk relationship and display at least some of the associated existing attribute values. The server may receive adjustments to some of the existing attribute values, and displayed information may be automatically and dynamically configured based on the received adjustments and a pre-determined logic rule. When an adjusted attribute value differs from an existing attribute value by more than a threshold amount, a confirmation signal from a user device may be requested. When adjustments have been completed, the server may automatically estimate an adjusted resource value based on the existing resource value, the adjusted attribute values, and an estimation algorithm.

Some embodiments comprise: means for accessing, by a back-end application computer server, an existing risk relationship data store containing electronic records representing a plurality of existing risk relationships with an enterprise and, for each existing risk relationship, an electronic record identifier and a set of existing attribute values including an existing resource value; means for receiving an indication of a selected risk relationship, between the enterprise and a user, from the existing risk relationship data store, including the associated set of existing attribute values; means for arranging to display at least some of the existing attribute values on an interactive user interface display; means for receiving, from a remote user device, adjustments to at least some of the existing attribute values, wherein the information on the interactive user interface display is automatically and dynamically configured based on the received adjustments and at least one pre-determined logic rule; when an adjusted attribute value differs from an existing attribute value by more than a pre-determined threshold amount, means for requesting a confirmation signal from the remote user device; means for receiving, from the remote user device, an indication that adjustments to existing attribute values have been completed; responsive to the received indication, means for automatically calculating an adjusted resource value based on the existing resource value, the adjusted attribute values, and an estimation algorithm; and means for transmitting an indication of the adjusted resource value to the remote user device.

In some embodiments, a communication device associated with a back-end application computer server exchanges information with remote devices in connection with an interactive graphical user interface. The information may be exchanged, for example, via public and/or proprietary communication networks.

A technical effect of some embodiments of the invention is an improved and computerized way to update existing electronic record information in a way that provides faster, more accurate results. With these and other advantages and features that will become hereinafter apparent, a more complete understanding of the nature of the invention can be obtained by referring to the following detailed description and to the drawings appended hereto.

### BRIEF DESCRIPTION OF THE DRAWINGS

FIG. 1 is a high-level block diagram of a system in accordance with some embodiments.

FIG. 2 illustrates a method according to some embodiments of the present invention.

FIG. 3 is an example of an introduction or landing page display for an insurance policy update tool in accordance with some embodiments.

FIG. 4 is an example of a business information display according to some embodiments.

FIG. 5 is an example of an additional portion of a business information display in accordance with some embodiments.

FIG. 6 is an example of an owners and officers portion of a business information display according to some embodiments.

FIG. 7 is an example of an employee information display in accordance with some embodiments.

FIG. 8 is an example of an addition portion of an employee information display according to some embodiments.

FIG. 9 is an example of a payroll and wage verification display in accordance with some embodiments.

FIG. 10 is an example of an additional information display according to some embodiments.

FIG. 11 is an example of a documents display in accordance with some embodiments.

FIG. 12 is an example of a review and submit display according to some embodiments.

FIG. 13 is an example of a successful submission display in accordance with some embodiments.

FIG. 14 is a more detailed block diagram of a system according to some embodiments.

FIG. 15 is a block diagram of an apparatus in accordance with some embodiments of the present invention.

FIG. 16 is a portion of a tabular existing risk relationship database according to some embodiments.

FIG. 17 illustrates a tablet computer displaying a resource allocation user interface according to some embodiments.

FIG. 18 illustrates an overall process in accordance with some embodiments.

### DETAILED DESCRIPTION

The present invention provides significant technical improvements to facilitate electronic messaging and dynamic data processing. The present invention is directed to more than merely a computer implementation of a routine or conventional activity previously known in the industry as it significantly advances the technical efficiency, access and/or accuracy of communications between devices by implementing a specific new method and system as defined herein. The present invention is a specific advancement in the area of electronic record attribute update and/or analysis by providing benefits in data accuracy, data availability and data integrity and such advances are not merely a longstanding commercial practice. The present invention provides improvement beyond a mere generic computer implementation as it involves the processing and conversion of significant amounts of data in a new beneficial manner as well as the interaction of a variety of specialized client and/or third-party systems, networks, and subsystems. For example, in the present invention information may be processed, updated, and analyzed via a back-end-end application server to accurately improve the exchange of information, thus improving the overall efficiency of the system associated with message storage requirements and/or bandwidth considerations (e.g., by reducing the number of messages that need to be transmitted via a network). Moreover, embodiments associated with collecting accurate information might further improve risk values, predictions of risk values, allocations of resources, electronic record processing decisions, etc.

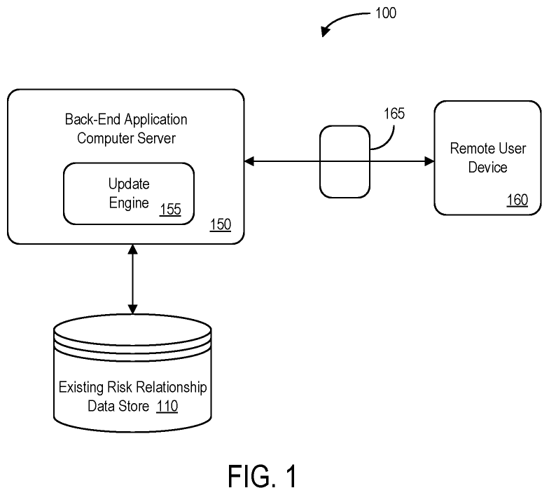

In some cases, a resource value associated with an enterprise system may depend at least in part on attribute values of electronic records representing a plurality of existing risk associations with the enterprise system. For example, the resource value might tend to increase when a specific type of attribute value increases (or decrease when another type of attribute value increases). Manually entering information to update attribute values by an enterprise, however, can be a time consuming and error prone process, especially when a substantial number of electronic records and/or attribute variables may influence the behavior of the system. For example, FIG. 1 is a high-level block diagram of a system 100 according to some embodiments of the present invention. In particular, the system 100 includes a back-end application computer 150 server that may access information in an existing risk relationship data store 110 (e.g., storing a set of electronic records representing risk associations, each record including, for example, one or more risk relationship identifiers, attribute variables, resource values, etc.). The back-end application computer server 150 may also retrieve information from other data stores or sources in connection with an update engine 155 to verify and/or update the electronic records. The back-end application computer server 150 may also exchange information with a remote user device 160 (e.g., via a firewall 165). According to some embodiments, an interactive graphical user interface platform of the back-end application computer server 150 (and, in some cases, third-party data) may facilitate forecasts, decisions, predictions, and/or the display of results via one or more remote administrator computers (e.g., to gather additional information about an existing association) and/or the remote user device 160. For example, the remote user device 160 may transmit updated information to the back-end application computer server 150. Based on the updated information, the back-end application computer server 150 may adjust data in the existing risk relationship data store 110 and automatically calculate an adjusted resource value. Note that the back-end application computer server 150 and/or any of the other devices and methods described herein might be associated with a third party, such as a vendor that performs a service for an enterprise.

The back-end application computer server 150 and/or the other elements of the system 100 might be, for example, associated with a Personal Computer (“PC”), laptop computer, smartphone, an enterprise server, a server farm, and/or a database or similar storage devices. According to some embodiments, an “automated” back-end application computer server 150 (and/or other elements of the system 100) may facilitate updates of electronic records in the existing risk relationship data store 110. As used herein, the term “automated” may refer to, for example, actions that can be performed with little (or no) intervention by a human.

As used herein, devices, including those associated with the back-end application computer server 150 and any other device described herein may exchange information via any communication network which may be one or more of a Local Area Network (“LAN”), a Metropolitan Area Network (“MAN”), a Wide Area Network (“WAN”), a proprietary network, a Public Switched Telephone Network (“PSTN”), a Wireless Application Protocol (“WAP”) network, a Bluetooth network, a wireless LAN network, and/or an Internet Protocol (“IP”) network such as the Internet, an intranet, or an extranet. Note that any devices described herein may communicate via one or more such communication networks.

The back-end application computer server 150 may store information into and/or retrieve information from the existing risk relationship data store 110. The existing risk relationship data store 110 might, for example, store electronic records representing a plurality of existing risk associations, each electronic record having a set of attribute values including a resource value. The existing risk relationship data store 110 may also contain information about prior and current interactions with parties, including those associated with the remote user devices 160. The existing risk relationship data store 110 may be locally stored or reside remote from the back-end application computer server 150. As will be described further below, the existing risk relationship data store 110 may be used by the back-end application computer server 150 in connection with an interactive user interface to update electronic records. Although a single back-end application computer server 150 is shown in FIG. 1, any number of such devices may be included. Moreover, various devices described herein might be combined according to embodiments of the present invention. For example, in some embodiments, the back-end application computer server 150 and a payroll server might be co-located and/or may comprise a single apparatus.

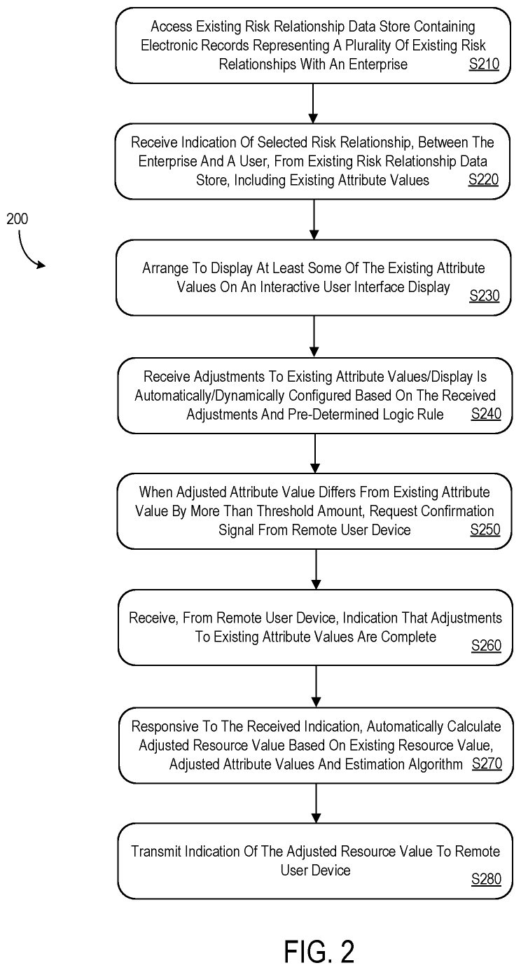

Note that the system 100 of FIG. 1 is provided only as an example, and embodiments may be associated with additional elements or components. According to some embodiments, the elements of the system 100 automatically transmit information associated with an interactive user interface display over a distributed communication network. FIG. 2 illustrates a method 200 that might be performed by some or all of the elements of the system 100 described with respect to FIG. 1, or any other system, according to some embodiments of the present invention. The flow charts described herein do not imply a fixed order to the steps, and embodiments of the present invention may be practiced in any order that is practicable. Note that any of the methods described herein may be performed by hardware, software, or any combination of these approaches. For example, a computer-readable storage medium may store thereon instructions that when executed by a machine result in performance according to any of the embodiments described herein.

At S210, a back-end application computer server may access an existing risk relationship data store containing electronic records representing a plurality of existing risk relationships with an enterprise and, for each existing risk relationship, an electronic record identifier and a set of existing attribute values including an existing resource value. At S220, an indication of a selected risk relationship, between the enterprise and a user, may be received from the existing risk relationship data store, including the associated set of existing attribute values.

At S230, at least some of the existing attribute values may be displayed on an interactive user interface display. For example, the display might be pre-populated with current attribute values and/or data provided during a prior year's update or audit. According to some embodiments, information from the existing risk relationship data store is supplemented third-party data, governmental data (e.g., from a department of motor vehicles, the Internal Revenue Service (“IRS”), a state tax department, etc.), payroll data (e.g., a total number of employees, job descriptions, salary data, etc.), credit score data, etc.

At S240, adjustments to at least some of the existing attribute values may be received from a remote user device. According to some embodiments, the information on the interactive user interface display is automatically and dynamically configured based on the received adjustments and at least one pre-determined logic rule. The pre-determined logic rule might be based at least in part on a geographic location associated with the selected risk relationship and a governmental requirement. For example, a customer located in New York might receive and/or update different information as compared to a customer located in California. The pre-determined logic rule could also be based at least in part on an industry associated with the selected risk relationship. For example, a dry cleaner business might receive and/or update different information as compared to a medical office. As still other examples, the display might be automatically and/or dynamically configured based on: an entity type associated with the selected risk relationship (e.g., a sole proprietorship might receive different questions as compared to a Limited Liability Company (“LLC”)); a class code associated with the selected risk relationship (e.g., is the restaurant a fast food or fine dining establishment, a line of business associated with the selected risk relationship, etc.

At S250, it may be determined if an adjusted attribute value differs from an existing attribute value by more than a pre-determined threshold amount. If so, the system may request a confirmation signal from the remote user device. For example, if a business had reported that it had 15 employees during last year's audit and is currently indicating that is 160 employees, the system might ask the business to confirm that the new number is correct (and not, for example, a typographical error).

At S260, an indication that adjustments to existing attribute values have been completed may be received from the remote user device. For example, a customer may select to “submit” a survey of updated information. At S270, and responsive to the received indication, the system may automatically calculate an adjusted resource value (e.g., an insurance premium) based on the existing resource value (e.g., a current insurance premium), the adjusted attribute values, and an estimation algorithm (e.g., a machine learning algorithm based on changes to other customer's insurance premiums). At S280, the system may transmit an indication of the adjusted resource value to the remote user device. The information might be transmitted, for example, via a web page, an email server, a text message, a calendar function, a workflow application, etc. According to some embodiments, the back-end application server may utilize a chatbot text interface, a streaming video interface, voice recognition, etc.

According to some embodiments, the back-end application computer server is further programmed to upload an attachment file from the remote user device. For example, the remote user device might upload an image file, a spreadsheet application, file, etc. in support of updates being made to an electronic record. In such cases, the back-end application computer server might supplement the information from the existing risk relationship data store with at least one value extracted from the attachment file (e.g., based on a cell label, an Optical Character Recognition (“OCR”) process, etc.).

In some embodiments, a state of adjustments to existing attribute values for the selected risk relationship may be stored and later accessed by the user. For example, a user might update half of the existing attribute values via a web site and “save” the updates. The user may then leave the web site. When the user later returns to the web site, he or she may select to reload those changes (e.g., after entering a username and password) and process to update the other half of attribute values.

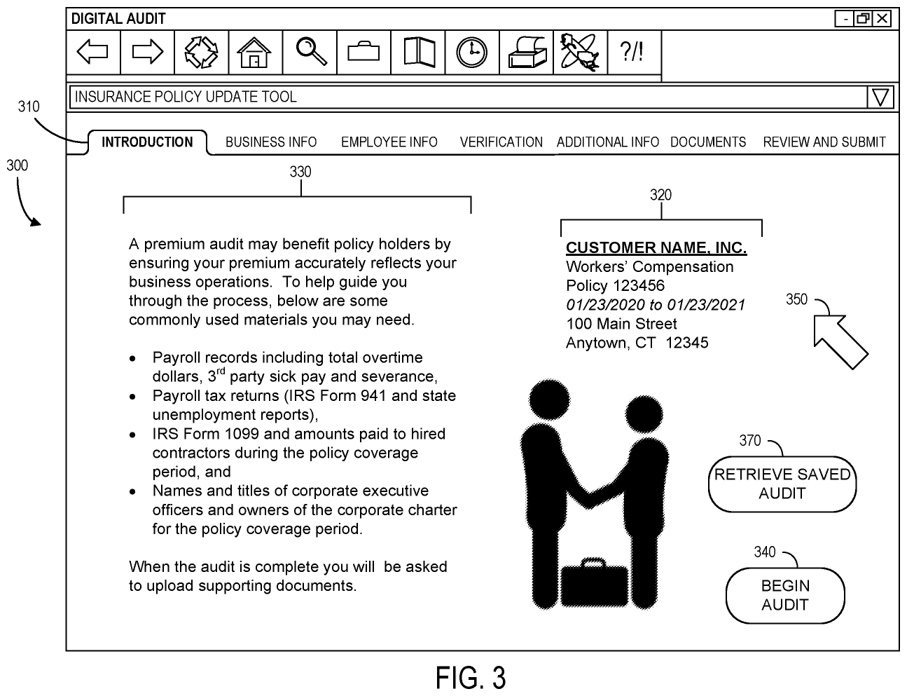

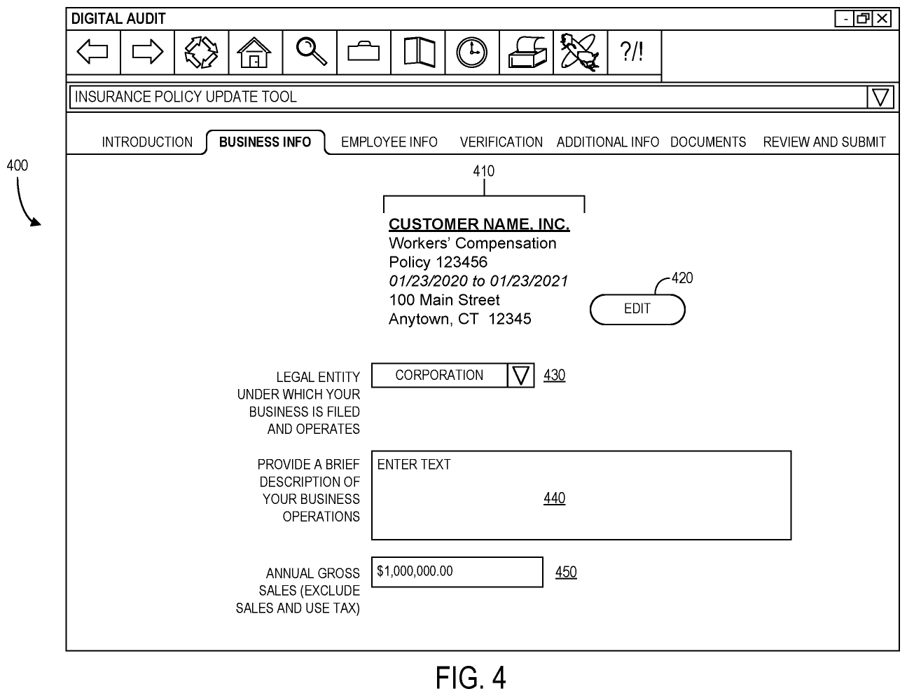

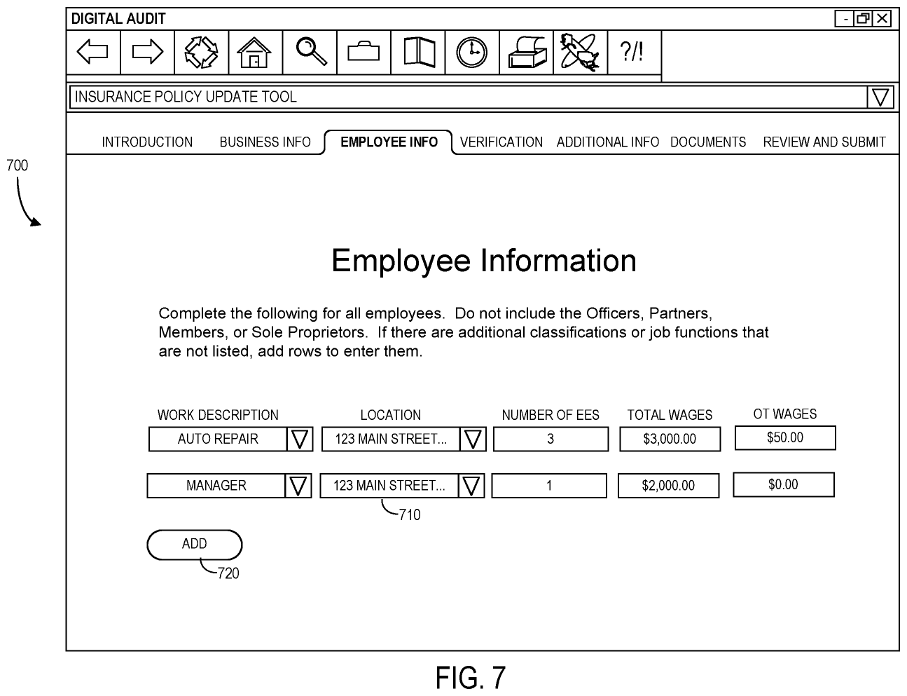

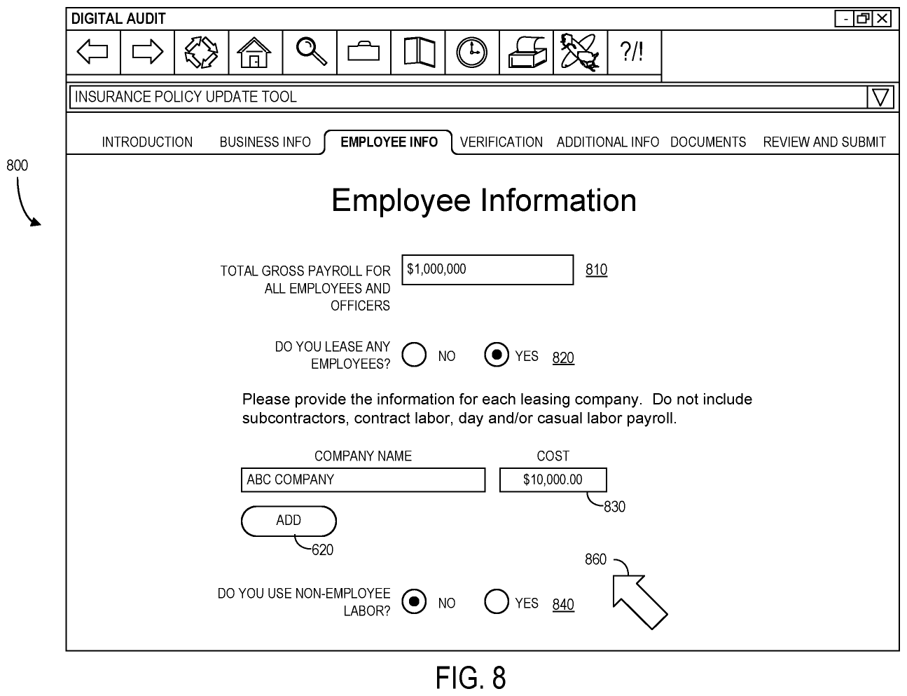

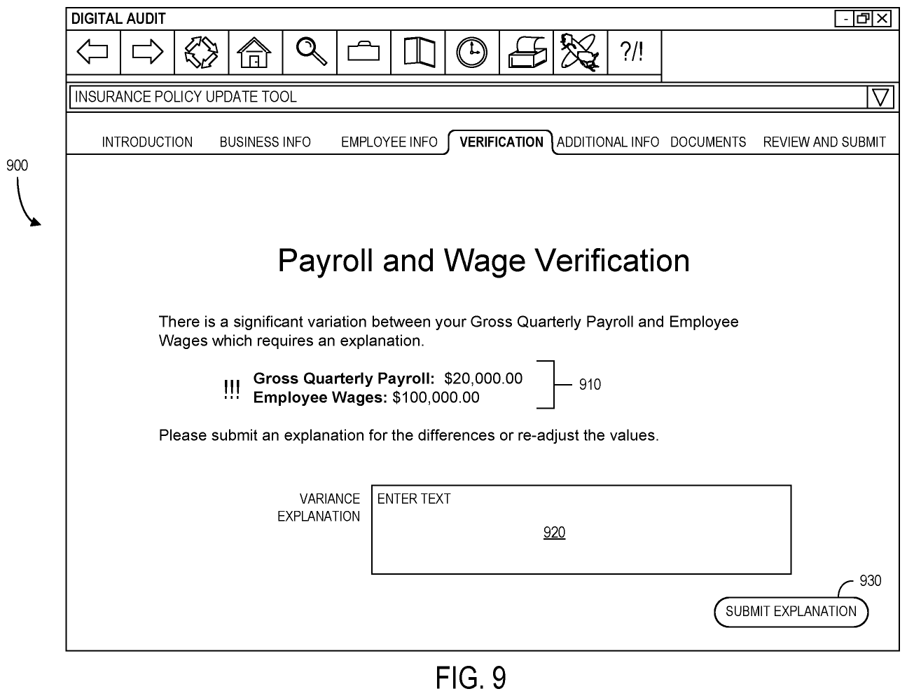

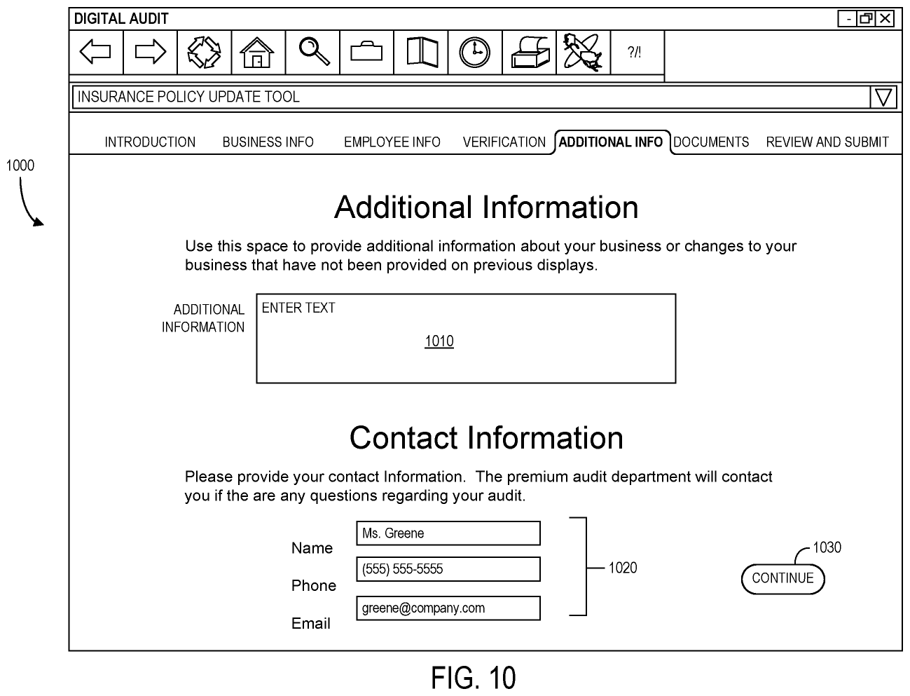

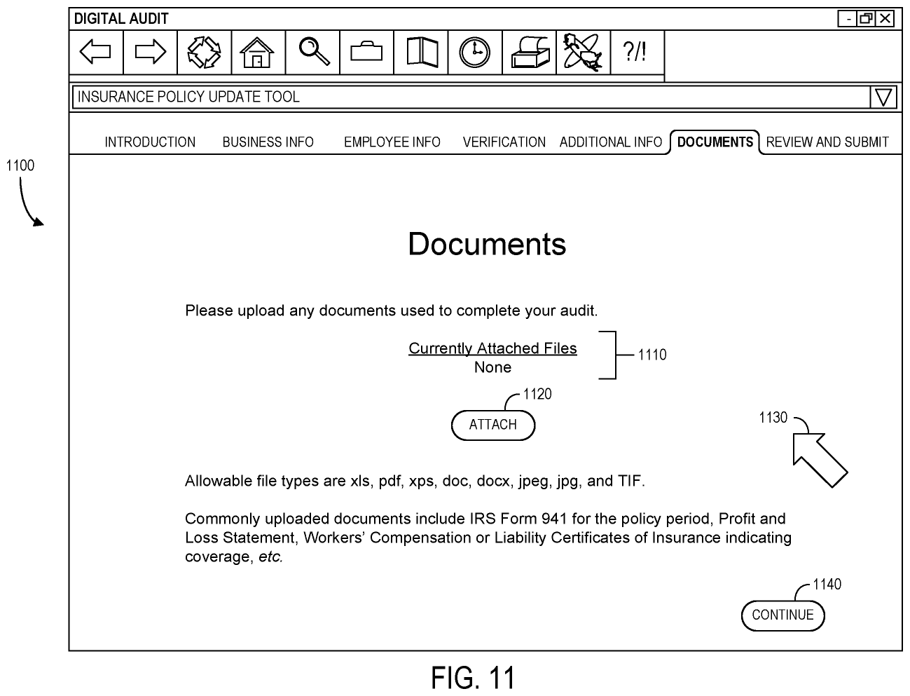

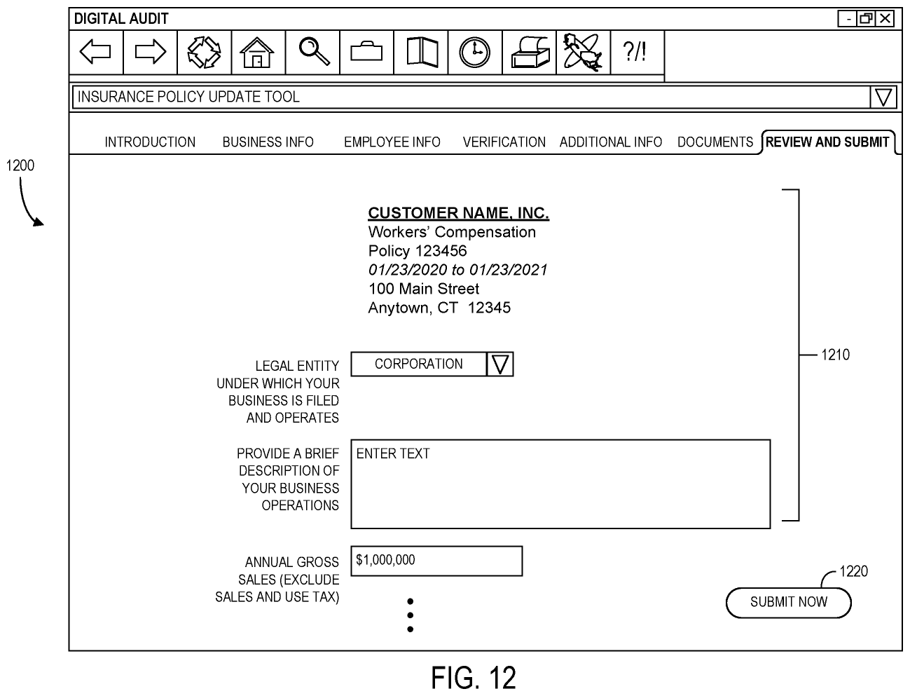

In this way, a system may let a user update electronic records associated with an existing risk relationship between with an enterprise. According to some embodiments, the existing “risk relationships” are associated with insurance policies and the existing resource value is associated with an insurance premium. In this case, the update may comprise an insurance policy renewal “audit” associated with workers' compensation insurance, business insurance, general liability insurance, automobile coverage, etc. As used herein, the term “audit” may refer to, for example, a process through which an insurance company verifies reported payroll or revenues of a policyholder to ensure that the policy reflects accurate rating information. FIG. 3 is an example of an introduction or landing page display 300 for an insurance policy update tool in accordance with some embodiments. The display 300 includes selectable audit portion selection tabs 310 that let a user access: the introduction portion (the current display 300); a business information portion (described with respect to FIGS. 4 through 6); an employee information portion (described with respect to FIGS. 7 and 8); a verification portion (described with respect to FIG. 9); an additional information portion (described with respect to FIG. 10); a documents portion (described with respect to FIG. 11); and a review and submit portion (described with respect to FIG. 12).

The display 300 further includes an existing customer information area 320 that might include, for example, a customer name, a type of insurance, an insurance policy number, an insurance policy term, a customer address, etc. The display 300 also includes an introductory message 330 (e.g., describing the audit process and listing some documentation that might be helpful) and a “Begin Audit” icon 340. Selection of the “Begin Audit” icon 340 by a touchscreen or computer mouse pointer 350 might start a process to update an electronic record associated with an insurance policy. According to some embodiments, a user might instead select a “Retrieve Saved Audit” icon 370 to continue an update that he or she previously saved.

According to some embodiments, adjustments to existing attribute values include adjustments to business information, such as a business name, a business address, contact information, a legal entity type, an annual gross sales value, quarterly information, payroll information, owner and officer information, etc. For example, FIG. 4 is a business information display 400 according to some embodiments. The display includes an existing customer information area 410 including a customer name, a type of insurance, an insurance policy number, an insurance policy term, a customer address, etc. A user can update or correct this data by selecting an “Edit” icon 420. The display 400 also includes a legal entity selection 430 (e.g., a drop-down menu) that can be used to update the type of entity under which a business is filed and operated. A description text box 440 may let a user provide a brief description of business operations (e.g., describing products or services provided by the business). An annual gross sales entry area 450 may let a user indicate a value that excludes sales and use tax amounts.

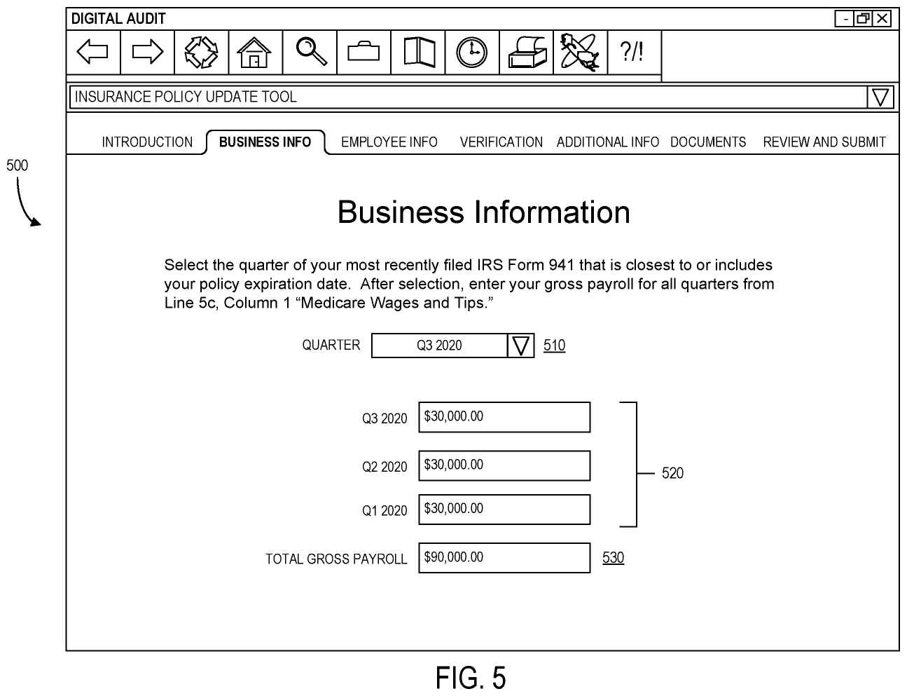

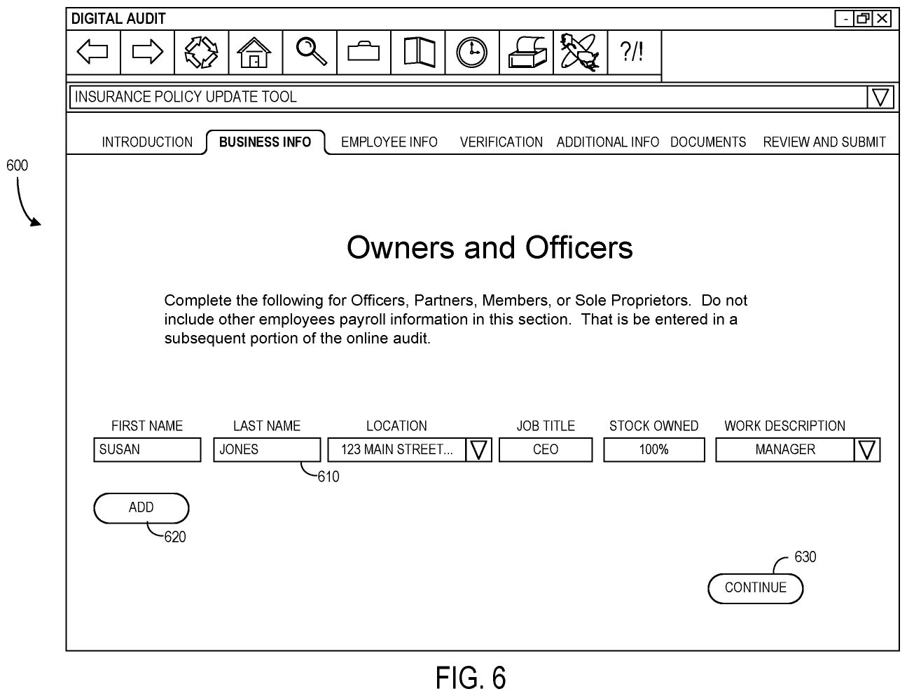

FIG. 5 is an example of an additional portion of a business information display 500 in accordance with some embodiments. The display 500 includes a quarter selection 510 (e.g., from a drop-down menu) that can be used to indicate the fiscal quarter of a most recently filed IRS Form 941 that is closest to or includes an insurance policy expiration date. The display 500 also includes quarterly data entry areas 520 and a total gross payroll area 530 to provide more detailed information. FIG. 6 is an example of an owners and officers portion of a business information display 600 according to some embodiments. The display includes owners and officers information fields 610 including first name, last name, location, job title, stock ownership data, and a work description for each owner or officer. An “Add” icon 620 can be used to provide additional owners or officers. When the owners and officers information is complete, a user may select a “Continue” icon 630 to proceed to an employee information portion of the insurance audit.

According to some embodiments, the adjustments to existing attribute values include adjustments to employee information, such as an employee name, a work description, a location, wage information, leased employee information, subcontractor information, waiver of subrogation information, etc. For example, FIG. 7 is an employee information display 700 in accordance with some embodiments. The display 700 includes employee information fields 710 that may include a description of work, a location, a number of employees, total gross wages, overtime wages, time-and-a-half wages, double-time wages, etc. An “Add” icon 720 can be used to provide additional job descriptions. FIG. 8 is an example of an addition portion of an employee information display 800 according to some embodiments. The display includes a total gross payroll entry area 810 and an indication of whether or not any employees are leased 820. Note that the display 800 may be automatically and dynamically configured according to some embodiments. For example, leased company data fields 830 (e.g., company name and cost) might only be displayed when the indication 820 “yes” is selected (and removed otherwise). Similarly, an indication of whether or not non-employee labor is used 840 may be selected with a computer mouse pointer 860 and result in the display of additional input fields when appropriate. Depending on state law, the display 800 might further ask for individual worker names and wage data and/or waiver of subrogation information.

FIG. 9 is an example of a payroll and wage verification display 900 in accordance with some embodiments. The display 900 may include a discrepancy alert 910 when it is determined that an adjusted attribute values differs from an existing attribute value by more than a pre-determined amount (e.g., a percentage amount, a dollar amount, etc.). The display may further include a variance text box 920 that can be used to provide an explanation for the variance (e.g., the business merged with another company resulting in an unusual increase in the number of employees). When the display 900 is complete, the user may select a “Submit Explanation” icon 930 to continue with the audit process.

FIG. 10 is an example of an additional information display 1000 according to some embodiments. The display 1000 includes an “Additional Information” text box 1010 that can be used to provide additional information about a business or changes that have not been provided on previous displays. Other information on the display additional information data fields 1020 (e.g., contact information) and a “Continue” icon 1030 that may be selected to proceed with the insurance audit process.

FIG. 11 is an example of a documents display 1100 in accordance with some embodiments. The display includes a list of currently attached files 1110 (e.g., image files, spreadsheet application files, etc.). An “Attach” icon 1120 may be selected to upload additional documents. According to some embodiments, a user may “drag-and-drop” document icons (e.g., from a computer operating system desktop) via a computer mouse pointer 1130 to add additional filed. When all documents have been attached to support the insurance audit, the user may select a “Continue” icon 1140 to proceed.

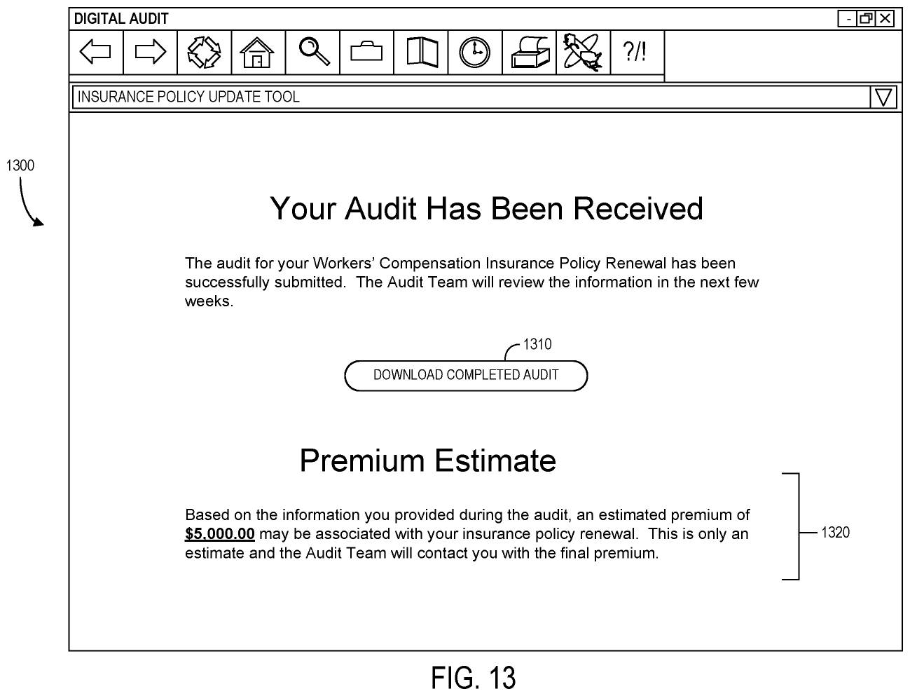

FIG. 12 is an example of a review and submit display 1200 according to some embodiments. The display 1200 might include review data 1210 that user can view to verify the information entered as described with respect to FIGS. 4 through 11. When the information is verified, a “Submit Now” icon 1220 may be used to transmit the updates to an insurance enterprise. FIG. 13 is an example of a successful submission display 1300 in accordance with some embodiments. According to some embodiments, a user may select a “Download Completed Audit” icon 1310 to receive a file (e.g., an image file or pdf) including all of the submitted data. According to some embodiments, the display 1300 may further include a premium estimate explanation 1320. The premium estimate 1320 might be based on, for example, last year's insurance premium, the adjusted audit information, and an estimation algorithm.

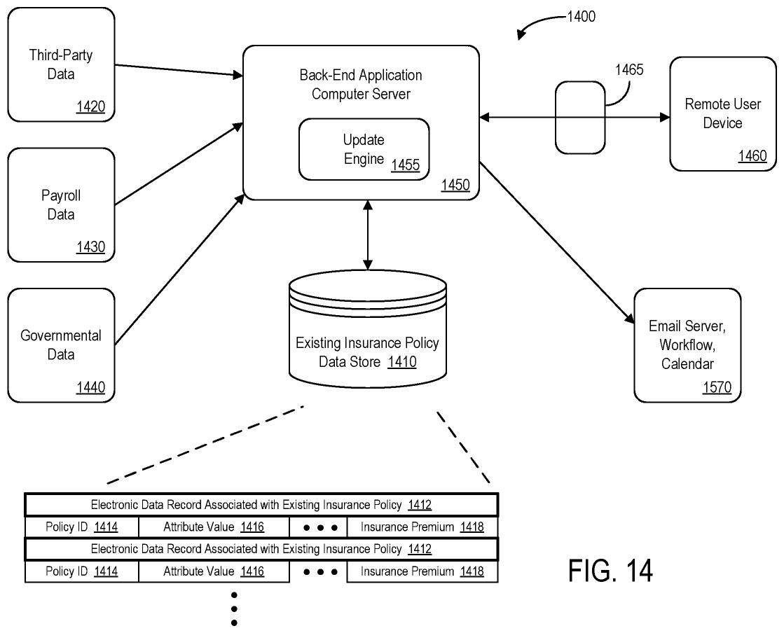

FIG. 14 is a more detailed block diagram of a system 1400 according to some embodiments. As before, the system 1400 includes a back-end application computer server 1450 that may access information in an existing insurance policy data store 1410 (e.g., storing a set of electronic records 1412 representing insurance policies, each record including, for example, one or more insurance policy identifiers 1414, attribute variables 1416, insurance premiums 1418, etc.). The back-end application computer server 1450 may also retrieve information from other data stores or sources in connection with an update engine 1455 to verify and/or update the electronic records. The back-end application computer server 1450 may also exchange information with a remote user device 1460 (e.g., via a firewall 1465). According to some embodiments, an interactive graphical user interface platform of the back-end application computer server may facilitate forecasts, decisions, predictions, and/or the display of results via one or more remote administrator computers (e.g., to gather additional information about an existing association) and/or the remote user device 1460.

According to some embodiments, the back-end application computer server 1450 may also receive external information, such as third-party data 1420, payroll data 1430, and governmental data 1440. This data might be used, for example, to pre-populate fields in an audit web site. A user may then review the information via the remote user device 1460 and transmit updated information to the back-end application computer server 1450. Based on the updated information, the back-end application computer server 1450 may adjust data in the existing insurance policy data store 1410 and automatically calculate an estimate adjusted insurance premium 1418. According to some embodiments, the back-end application computer server 1450 may transmit information to an email server, workflow application, or calendar function 1570 (e.g., to generate reminders when an insurance policy renewal date approaches). Similarly, the back-end application computer server 1450 might transmit updated electronic records 1412 to an underwriter device for manual review and a determination of a final insurance premium.

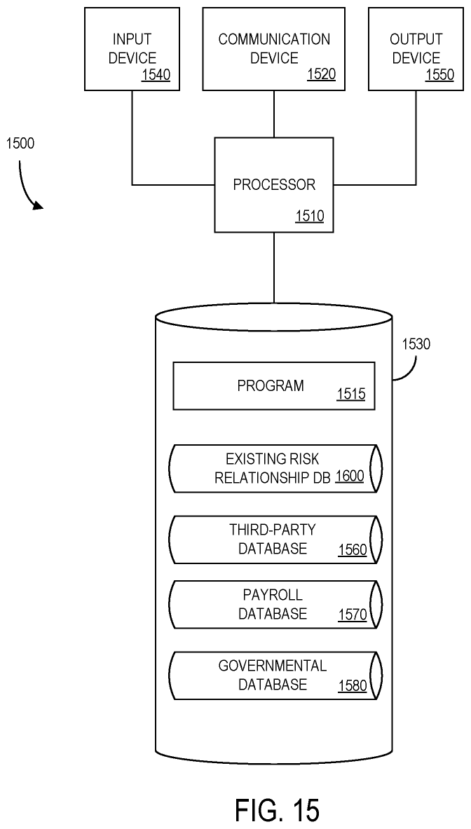

The embodiments described herein may be implemented using any number of different hardware configurations. For example, FIG. 15 illustrates an apparatus 1500 that may be, for example, associated with the systems 100, 1400 described with respect to FIGS. 1 and 14, respectively. The apparatus 1500 comprises a processor 1510, such as one or more commercially available Central Processing Units (“CPUs”) in the form of one-chip microprocessors, coupled to a communication device 1520 configured to communicate via a communication network (not shown in FIG. 15). The communication device 1520 may be used to communicate, for example, with one or more remote administrator computers and or communication devices (e.g., PCs and smartphones). Note that communications exchanged via the communication device 1520 may utilize security features, such as those between a public internet user and an internal network of the insurance enterprise. The security features might be associated with, for example, web servers, firewalls, and/or PCI infrastructure. The apparatus 1500 further includes an input device 1540 (e.g., a mouse and/or keyboard to enter information about pre-determined logic rules to automatically and dynamically adjust a data input flow, etc.) and an output device 1550 (e.g., to output reports regarding insurance audits).

The processor 1510 also communicates with a storage device 1530. The storage device 1530 may comprise any appropriate information storage device, including combinations of magnetic storage devices (e.g., a hard disk drive), optical storage devices, mobile telephones, and/or semiconductor memory devices. The storage device 1530 stores a program 1515 and/or a risk evaluation tool or application for controlling the processor 1510. The processor 1510 performs instructions of the program 1515, and thereby operates in accordance with any of the embodiments described herein. For example, the processor 1510 may access an existing risk relationship database 1600 that contains electronic records representing a plurality of existing risk relationships and, for each existing risk relationship, an electronic record identifier and a set of existing attribute values including an existing resource value. The processor 1510 may receive an indication of a selected risk relationship and display at least some of the associated existing attribute values. The processor 1510 may receive adjustments to some of the existing attribute values, and displayed information may be automatically and dynamically configured based on the received adjustments and a pre-determined logic rule. When an adjusted attribute value differs from an existing attribute value by more than a threshold amount, a confirmation signal from a user device may be requested. When adjustments have been completed, the processor 1510 may automatically estimate an adjusted resource value based on the existing resource value, the adjusted attribute values, and an estimation algorithm.

The program 1515 may be stored in a compressed, uncompiled and/or encrypted format. The program 1515 may furthermore include other program elements, such as an operating system, a database management system, and/or device drivers used by the processor 1510 to interface with peripheral devices.

As used herein, information may be “received” by or “transmitted” to, for example: (i) the back-end application computer server 1500 from another device; or (ii) a software application or module within the back-end application computer server 1500 from another software application, module, or any other source.

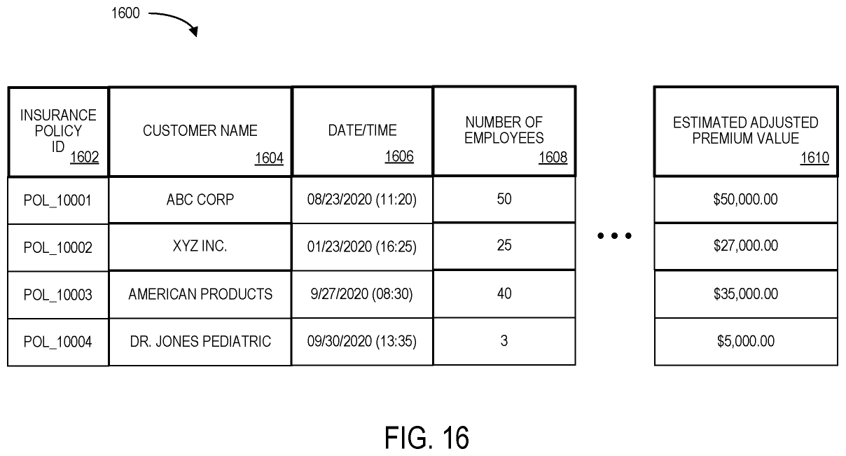

In some embodiments (such as shown in FIG. 15), the storage device 1530 further stores the existing risk relationship database 1600, a third-party database 1560 (e.g., storing a list of business address and phone numbers that may be used to pre-populate fields on an audit web site), a payroll database 1570 (e.g., storing employee name and salary data), and a governmental database 1580 (e.g., storing motor vehicle records, tax information, etc.). An example of a database that might be used in connection with the apparatus 1500 will now be described in detail with respect to FIG. 16. Note that the database described herein is only an example, and additional and/or different information may be stored therein. Moreover, various databases might be split or combined in accordance with any of the embodiments described herein. For example, the existing risk relationship database 1600 and payroll database 1570 might be combined and/or linked to each other within the program 1515.

Referring to FIG. 16, a table is shown that represents the existing risk relation database 1600 that may be stored at the apparatus 1600 according to some embodiments. The table may include, for example, entries associated with insurance policies for which an audit may be performed. The table may also define fields 1602, 1604, 1606, 1608, 1610 for each of the entries. The fields 1602, 1604, 1606, 1608, 1610 may, according to some embodiments, specify: an insurance policy identifier 1602, a customer name 1604, a date and time 1606, a number of employees 1608, and an estimated adjusted premium value 1610. The existing risk relation database 1600 may be created and updated, for example, based on information electrically received from various computer systems, including those associated with an existing insurance customer.

The insurance policy identifier 1602 may be, for example, a unique alphanumeric code identifying an insurance policy that needs to have an audit performed (e.g., because of an upcoming policy renewal date). The customer name 1604 may be associated with the insured, and the date and time 1606 might indicate a renewal date, when audit updates are due, when audit updates are received. The database 1600 may store various attributes associated with the insurance policy, such as the number of employees 1608, income information, overtime information, etc. The information in the existing risk relationship database 1600 may then be used to generate the estimated adjusted premium value 1610 that can be transmitted to the customer.

Thus, embodiments may provide an automated and efficient way to update existing electronic record information in a way that provides faster, more accurate results. Embodiments may also address the need for a consistent and objective determination of current insurance policy attributes.

The following illustrates various additional embodiments of the invention. These do not constitute a definition of all possible embodiments, and those skilled in the art will understand that the present invention is applicable to many other embodiments. Further, although the following embodiments are briefly described for clarity, those skilled in the art will understand how to make any changes, if necessary, to the above-described apparatus and methods to accommodate these and other embodiments and applications.

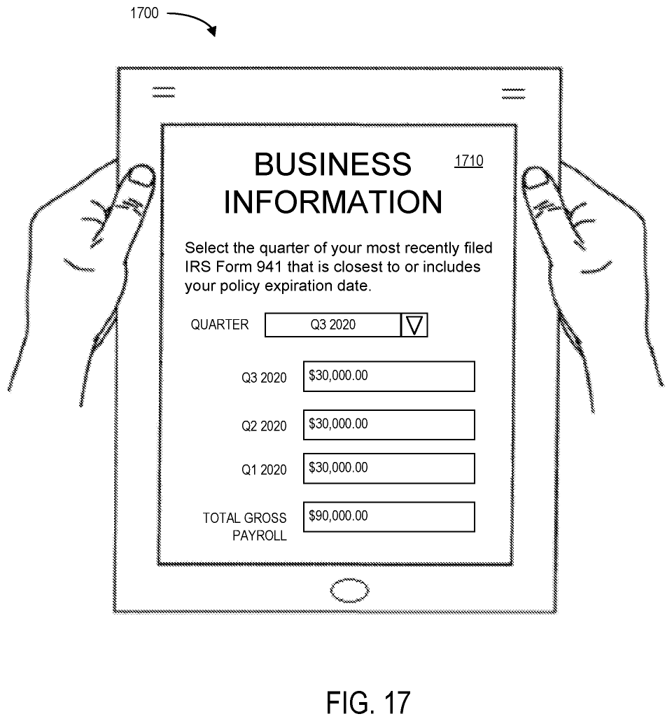

Although specific hardware and data configurations have been described herein, note that any number of other configurations may be provided in accordance with embodiments of the present invention (e.g., some of the information associated with the displays described herein might be implemented as a virtual or augmented reality display and/or the databases described herein may be combined or stored in external systems). Moreover, although embodiments have been described with respect to particular types of insurance policies, embodiments may instead be associated with other types of insurance policies in additional to and/or instead of the policies described herein (e.g., business insurance policies, automobile insurance policies, etc.). Similarly, although certain attributes were described in connection some embodiments herein, other types of attributes might be used instead. Still further, the displays and devices illustrated herein are only provided as examples, and embodiments may be associated with any other types of user interfaces. For example, FIG. 17 illustrates a handheld tablet computer 1700 showing a business information display 1710 according to some embodiments. The business information display 1710 might include user-selectable data that can be selected and/or modified by a user of the handheld computer 1700 to provide updated audit information to an insurance enterprise.

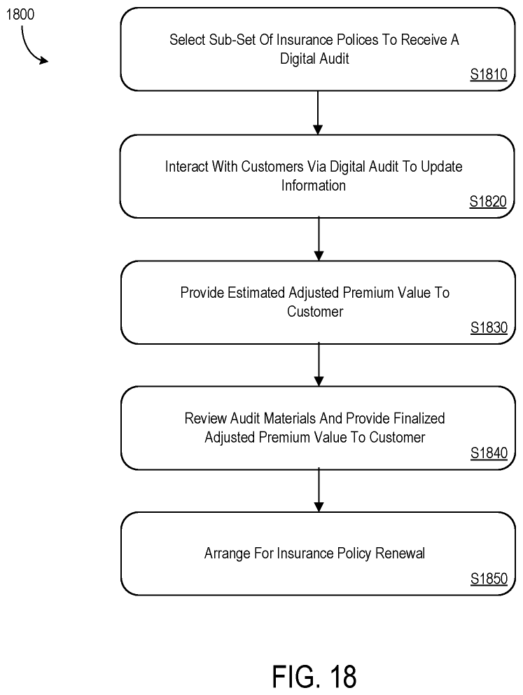

FIG. 18 illustrates an overall process 1800 in accordance with some embodiments. At S1810, an enterprise may select a sub-set of insurance policies to receive a digital audit. The enterprise might, for example, group various small commercial and/or middle market customers to schedule field audits (where a representative of the enterprise visits a business to verify information) and telephone audits. To reduce the expense of such audits, the enterprise may select certain insurance policies to be updated via an online digital audit in accordance with any of the embodiments described herein. At S1820, the enterprise may interact with customers via the digital audit to update insurance policy information. At S1830, the enterprise may provide an estimated adjusted premium value to a customer based on the updated insurance policy information. At S1840, the enterprise may review audit materials and provide a finalized adjusted premium value to the customer (e.g., after an underwriter reviews the updated audit materials). At S1850, the enterprise may arrange for the insurance policy to be renewed.

The present invention has been described in terms of several embodiments solely for the purpose of illustration. Persons skilled in the art will recognize from this description that the invention is not limited to the embodiments described, but may be practiced with modifications and alterations limited only by the spirit and scope of the appended claims.

What is claimed:

1. A system to update existing electronic record information via a back-end application computer server of an enterprise, comprising:
(a) an existing risk relationship data store containing electronic records representing a plurality of existing risk relationships with the enterprise and, for each existing risk relationship, an electronic record identifier and a set of existing attribute values including an existing resource value;
(b) the back-end application computer server, coupled to the existing risk relationship data store, programmed to:
(i) receive an indication of a selected risk relationship, between the enterprise and a user, from the existing risk relationship data store, including the associated set of existing attribute values,
(ii) arrange to display at least some of the existing attribute values on an interactive user interface display,
(iii) receive, from a remote user device, adjustments to at least some of the existing attribute values, wherein the information on the interactive user interface display is automatically and dynamically configured based on the received adjustments and at least one pre-determined logic rule,
(iv) when an adjusted attribute value differs from an existing attribute value by more than a pre-determined threshold amount, request a confirmation signal from the remote user device,
(v) receive, from the remote user device, an indication that adjustments to existing attribute values have been completed,
(vi) responsive to the received indication, automatically estimate an adjusted resource value based on the existing resource value, the adjusted attribute values, and an estimation algorithm, and
(vii) transmit an indication of the adjusted resource value to the remote user device; and
(c) a communication port coupled to the back-end application computer server to facilitate a transmission of data with a remote user device to support the interactive user interface display via a distributed communication network.

2. The system of claim 1, wherein information from the existing risk relationship data store is supplemented with at least one of: (i) third-party data, (ii) governmental data, (iii) payroll data, and (iv) credit score data.

3. The system of claim 1, wherein the back-end application computer server is further programmed to:
upload an attachment file from the remote user device, and
supplement the information from the existing risk relationship data store with at least one value extracted from the attachment file.

4. The system of claim 1, wherein the pre-determined logic rule is based at least in part on a geographic location associated with the selected risk relationship and a governmental requirement.

5. The system of claim 1, wherein the pre-determined logic rule is based at least in part on an industry associated with the selected risk relationship.

6. The system of claim 1, wherein the pre-determined logic rule is based at least in part on at least one of: (i) an entity type associated with the selected risk relationship, (ii) a class code associated with the selected risk relationship, and (iii) (iii) a line of business associated with the selected risk relationship.

7. The system of claim 1, wherein a state of adjustments to existing attribute values for the selected risk relationship may be stored and later accessed by the user.

8. The system of claim 1, wherein the back-end application server is further programmed to utilize at least one of: (i) automatically generated email reminders, (ii) automatically generated text message reminders, (iii) a chatbot text interface, (iv) a streaming video interface, and (v) voice recognition.

9. The system of claim 1, wherein the existing risk relationships are associated with insurance policies and the existing resource value is associated with an insurance premium.

10. The system of claim 9, wherein the update comprises an insurance policy renewal audit associated with at least one of: (i) workers' compensation insurance, (ii) business insurance, (iii) general liability insurance, and (iv) automobile coverage.

11. The system of claim 9, wherein the adjustments to existing attribute values include adjustments to business information, including at least one of: (i) a business name, (ii) a business address, (iii) contact information, (iv) a legal entity type, (v) an annual gross sales value, (vi) quarterly information, (vii) payroll information, and (viii) owner and officer information.

12. The system of claim 9, wherein the adjustments to existing attribute values include adjustments to employee information, including at least one of: (i) an employee name, (ii) a work description, (iii) a location, (iv) wage information, (v) leased employee information, (vi) subcontractor information, and (vii) waiver of subrogation information.

13. A computerized method to update existing electronic record information via a back-end application computer server of an enterprise, comprising:
accessing, by the back-end application computer server, an existing risk relationship data store containing electronic records representing a plurality of existing risk relationships with the enterprise and, for each existing risk relationship, an electronic record identifier and a set of existing attribute values including an existing resource value;
receiving an indication of a selected risk relationship, between the enterprise and a user, from the existing risk relationship data store, including the associated set of existing attribute values;
arranging to display at least some of the existing attribute values on an interactive user interface display;
receiving, from a remote user device, adjustments to at least some of the existing attribute values, wherein the information on the interactive user interface display is automatically and dynamically configured based on the received adjustments and at least one pre-determined logic rule;
when an adjusted attribute value differs from an existing attribute value by more than a pre-determined threshold amount, requesting a confirmation signal from the remote user device;
receiving, from the remote user device, an indication that adjustments to existing attribute values have been completed;
responsive to the received indication, automatically calculating an adjusted resource value based on the existing resource value, the adjusted attribute values, and an estimation algorithm; and
transmitting an indication of the adjusted resource value to the remote user device.

14. The method of claim 13, wherein information from the existing risk relationship data store is supplemented with at least one of: (i) third-party data, (ii) governmental data, (iii) payroll data, and (iv) credit score data.

15. The method of claim 13, wherein the back-end application computer server is further programmed to:
upload an attachment file from the remote user device, and
supplement the information from the existing risk relationship data store with at least one value extracted from the attachment file.

16. The system of claim 13, wherein the pre-determined logic rule is based at least in part on a geographic location associated with the selected risk relationship and a governmental requirement.

17. The method of claim 13, wherein the pre-determined logic rule is based at least in part on an industry associated with the selected risk relationship.

18. The method of claim 13, wherein a state of adjustments to existing attribute values for the selected risk relationship may be stored and later accessed by the user.

19. A non-tangible, computer-readable medium storing instructions, that, when executed by a processor, cause the processor to perform a method to update existing electronic record information via a back-end application computer server of an enterprise, the method comprising:
accessing, by the back-end application computer server, an existing risk relationship data store containing electronic records representing a plurality of existing risk relationships with the enterprise and, for each existing risk relationship, an electronic record identifier and a set of existing attribute values including an existing resource value;
receiving an indication of a selected risk relationship, between the enterprise and a user, from the existing risk relationship data store, including the associated set of existing attribute values;
arranging to display at least some of the existing attribute values on an interactive user interface display;
receiving, from a remote user device, adjustments to at least some of the existing attribute values, wherein the information on the interactive user interface display is automatically and dynamically configured based on the received adjustments and at least one pre-determined logic rule;
when an adjusted attribute value differs from an existing attribute value by more than a pre-determined threshold amount, requesting a confirmation signal from the remote user device;
receiving, from the remote user device, an indication that adjustments to existing attribute values have been completed;
responsive to the received indication, automatically calculating an adjusted resource value based on the existing resource value, the adjusted attribute values, and an estimation algorithm; and
transmitting an indication of the adjusted resource value to the remote user device.

20. The medium of claim 19, wherein the existing risk relationships are associated with insurance policies and the existing resource value is associated with an insurance premium.
